(19) United States
(12) Patent Application Publication
(10) Pub. No.: US 2008/0165860 A1
(43) Pub. Date: Jul. 10, 2008

(54) H.264 Data processing

(76) Inventors: Zohair Sahraoui, North York (CA); Yingjian He, Markham (CA); Paul Chow, Richmond Hill (CA)

Correspondence Address: VOLPE AND KOENIG, P.C.;DEPT. AMD, UNITED PLAZA, SUITE 1600, 30 SOUTH 17TH STREET, PHILADELPHIA, PA, 19103, US

(21) Appl. No.: 11/897,714

(22) Filed: Aug. 30, 2007

Related U.S. Application Data
(60) Provisional application No. 60/842,001, filed on Aug. 31, 2006.

(51) Int. Cl. H04N 7/26

(52) U.S. Cl. 375/240.25; 375/E07.027

(57) ABSTRACT

Picture order count values are used to calculate a distance scale factor in the H.264 scheme. The distance scale factor can be used as a parameter in temporal direct prediction and weighted prediction. A decoder can operate on video slices containing picture data. Each video slice can contain references to previous and subsequent pictures using POC values. The POC values are stored as a 16-bit difference from an offset. An algorithm utilizes the POC values to output the distance scale factor. Embodiments of the invention can improve the efficiency of a decoder and can reduce storage requirements for POC values associated with H.264 video slices.

### CROSS-REFERENCE TO RELATED APPLICATIONS

This application claims the benefit of U.S. Provisional Application No. 60/842,001, filed on Aug. 31, 2006.

### BACKGROUND OF THE INVENTION

A video sequence contains pictures which can be divided into macroblocks when MPEG compression is used. Motion compensation is used to describe the difference between a current video picture portion (e.g., macroblock) and temporally adjacent and/or temporally nearby picture portions by describing motion between those picture portions. Motion compensation takes advantage of the fact that temporally nearby pictures often are very similar. By referring to the data of temporally nearby frames or fields, motion compensation can remove redundancy in video data to gain better compression ratios.

The H.264 video standard extends motion compensation, allowing video slices (groups of macroblocks) to refer to multiple nearby (e.g., temporally nearby or physically nearby) slices. In particular, macroblocks within each video slice can refer to information in macroblocks contained in up to 32 nearby pictures for temporally forward reference, and up to 32 nearby pictures for temporally backward reference. These nearby pictures are referred to by a 32-bit value called a Picture Order Count (POC). The POC values correspond to the Picture Order Count of the pictures used as a reference by the current slice. Picture order counts are used to determine initial picture orderings for reference pictures in the decoding of pictures. POC values act as locally unique timestamp values to refer to pictures. A decoder implementing the H.264 standard can store up to 32 forward-referenced POC values and 32 backwards-referenced POC values for each picture received. For each new picture, a new set of POC values is loaded and stored for use.

In addition to simple motion compensation, H.264 provides methods including temporal direct prediction and weighted prediction. Temporal direct prediction can interpolate a motion vector for a current macroblock using the motion vectors of macroblocks in temporally nearby slices. Weighted prediction is useful for fading between scenes. Both temporal direct prediction and weighted prediction make use of POC values of temporally nearby pictures. In particular, the POC values are used to calculate a distance scale factor, which is a parameter used in temporal direct prediction and weighted prediction.

### SUMMARY

In accordance with implementations of the invention, one or more of the following capabilities may be provided. POC values are used to calculate distance scale factors. The distance scale factors can be generated using lower bit values which can result in an image area savings. The storage requirement for POC tables and registers can be reduced.

In general, in an aspect, the invention provides a computer-readable medium having computer-executable instructions for performing a method for decoding video data, including receiving a first picture order count value associated with a first video picture and a second picture order count value associated with a second video picture, such that the picture order count values have a first bit length, computing a delta value representing a difference between the first picture order count value and the second picture order count value, such that the delta value has a second bit length that is less than the first bit length, and storing the delta value in a memory for use by a video processing algorithm.

Implementations of the invention may include one or more of the following features. The second bit length can be approximately half of the first bit length. The first bit length can be 32 bits and the second bit length can be 16 bits. The video processing algorithm can output a distance scale factor.

In general, in another aspect, the invention provides a method for decoding video data, including receiving a one or more picture order count values associated with one or more video pictures temporally adjacent to a current video picture, such that each of the picture count values are a first bit length, calculating one or more delta values representing a differences between the picture order count values and another value, such that each of the delta values are a second bit length that is less than the first bit length, and storing the delta values in a memory device for further processing of the current video picture.

Implementations of the invention may include one or more of the following features. The further processing of the current video picture can include outputting a distance scale factor. The second bit length can be approximately half of the first bit length. The second bit length can be 32 bits and the first bit length can be 16 bits.

In general, in another aspect, the invention provides an apparatus for processing a video sequence, including a memory device operative to store one or more first picture order count values, one or more second picture order count values, and a current picture order count value, a processor programmed to compute a first arithmetic operation between each of the first picture order count values and the current picture order count value, compute a second arithmetic operation between each of the second picture order count values and the current picture order count value, determine a distance scale factor based on the first and second arithmetic operations, and output the distance scale factor.

Implementations of the invention may include one or more of the following features. The first and second picture order count values can be first bit length, and the results of the first and second arithmetic operations can be a second bit length. The second bit length can be approximately half of the first bit length.

In general, in another aspect, the invention provides a system for outputting a distance scale factor to a video picture decoder, including a memory device operative to store one or more picture order difference values, a processor programmed to receive one or more reference index values, compute each of the picture order difference values by subtracting an offset value from each of the reference index values, storing each of the picture order difference values in the memory device, processing the picture order difference values with an algorithm to produce the distance scale factor, and outputting the distance scale factor.

Implementations of the invention may include one or more of the following features. Each of the reference index values can be a first bit length, and each of picture order difference values can be second bit length. The second bit length can be less than the first bit length. The second bit length can be 16 bits and the first bit length can be 32 bits.

These and other capabilities of the invention, along with the invention itself, will be more fully understood after a review of the following figures, detailed description, and claims.

### BRIEF DESCRIPTION OF THE FIGURES

FIG. 1 is a block diagram of a prior art system for storing POC values.

FIG. 2 is a block diagram of a system for storing and manipulating POC values in accordance with H.264 (MPEG-4.10).

FIG. 3 is a block diagram of a system for storing and manipulating POC values in accordance with an embodiment of the invention.

FIG. 4 is a block diagram of a system for storing and manipulating POC values in accordance with another embodiment of the invention.

### DETAILED DESCRIPTION PREFERRED EMBODIMENTS

Embodiments of the invention provide techniques for decoding a video signal. In general, a video signal decoder is a digital signal processing system including input and output components, memory components, and processing components. The decoder can execute computer instructions provided on a computer readable medium. A computer readable medium includes computer memory such as floppy disks, hard disks, CD-ROMS, Flash ROMS, nonvolatile ROM, and RAM. A decoder can be configured via hardware and software to process video signals based on a signal compression and decompression standard (i.e., scheme). For example, in the H.264 standard, a collection of Picture Order Count (POC) values can be used to calculate a distance scale factor, which is a parameter used in temporal direct prediction and weighted prediction algorithms within the decoder. The decoder receives and operates on video slices (e.g., pictures) containing picture data that conforms to the H.264 standard. In general, each of the video slices can contain references to previous and subsequent pictures using the POC values. In an example, the POC values can be stored as a 32-bit value. The POC values can also be stored as a 16-bit value, which is the result of subtracting an offset value from the 32-bit value. The lower bit value can reduce the storage required for POC values associated with H.264 video slices. This system is exemplary, however, and not limiting of the invention as other implementations in accordance with the disclosure are possible.

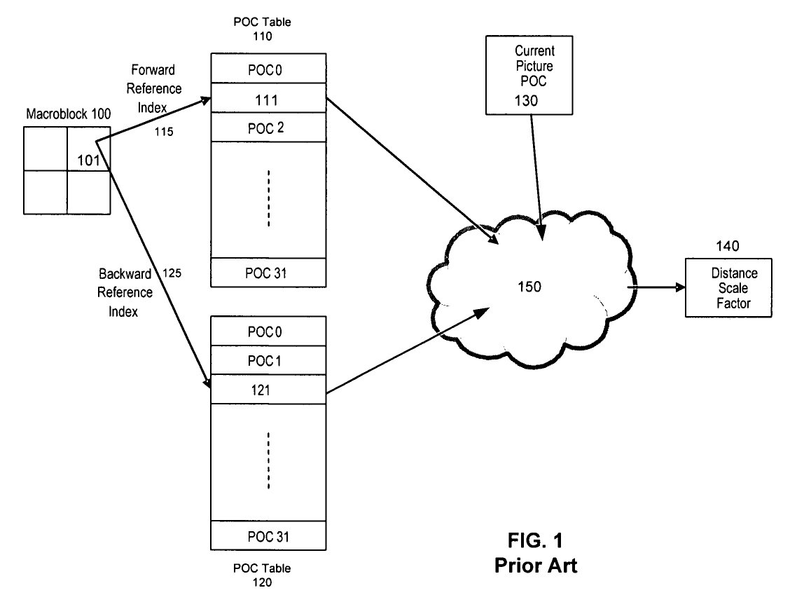

Referring to FIG. 1, a prior art system for handling POC values in a H.264 decoder is shown. The system includes a macroblock 100, POC tables 110, 120, a current picture POC 130, an algorithm 150, and a distance scale factor 140. The macroblock 100 includes at least one block 101, and the POC tables 110, 120 include a collection of POC values 111, 112. In general, the POC values 111 and 121 are utilized by the algorithm 150 to compute the distance scale factor 140. As discussed, the distance scale factor 140 is a parameter used to calculate temporal direct prediction and weighted prediction within a decoder. Each block 101 within the macroblock 100 can contain a different set of POC values (e.g. 111 and 121). For example, each block 101 utilizes forward reference indexes 115, and backward reference indexes 125, into tables of POC values 110 and 120. Indexes 115 indicate the POC values 111 that refers to a forward picture that will be used by the decoder to decode the block 101. Indexes 125 indicate the POC values 121 that refers to a backward picture that can be used by the decoder to decode the block 101. For example, in the H.264 scheme, each slice can refer to a maximum of 32 field pictures for forward reference, and a maximum of 32 field pictures for a backwards reference.

The algorithm 150 can be configured to compute the distance scale factor 140 from selected POC values 111 and 121 and the POC value 130 of the current picture being decoded. For example, the algorithm 150 can be performed by a processor (e.g., programmed with computer executable instructions), or a dedicated hardware circuit. In general, the operation of the algorithm 150 depends on the type of prediction the decoder is performing. In an embodiment, the type of prediction used by the decoder can be determined by an encoder of the picture. The encoder information can be indicated in a slice header of the picture being decoded. As an example, and not a limitation, the types of prediction that can utilize algorithm 150 include temporal direct prediction and weighted prediction.

In general, FIG. 1 represents a prior art implementation of a process for using the POC values 111, 121 to derive the distance scale factor 140. The POC values are read out directly from the POC tables 110, 120, and combined with, among other things, the POC value 130 of the current picture, and the algorithm 150 outputs the distance scale factor 140. Generally, this implementation uses the storage of the full precision of the POC values, i.e., 32 bit values, for both the forward and backward directions. The bit length of the POC values can impact the performance of the decoder, as well as the size of the memory required.

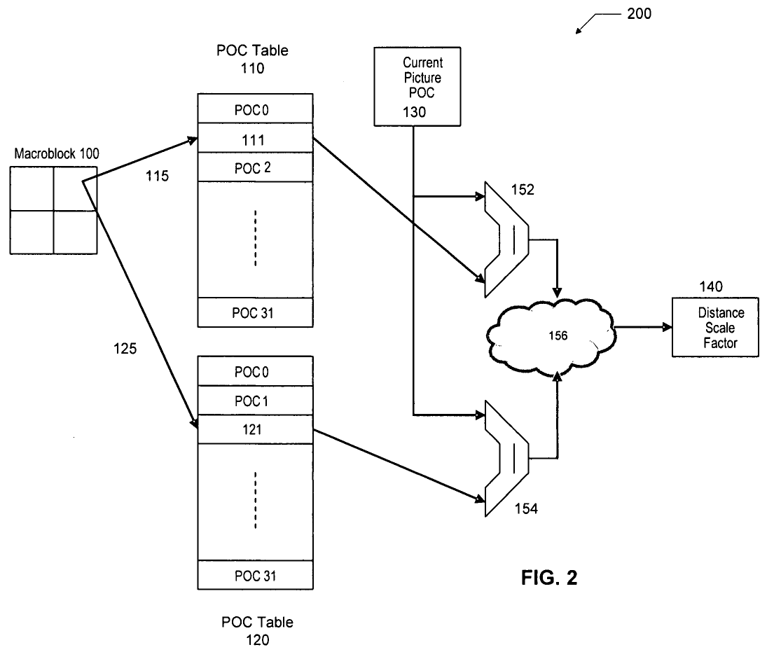

Referring to FIG. 2, with further reference to FIG. 1, a system 200 for calculating the distance factor 140 is shown. The system 200 includes two arithmetic operation 152, 154, and utilized a difference of POC values in an algorithm 156 to determine the distance scale factor 140. The arithmetic operations 152, 154 compare POC values from tables 110, 120. The algorithm 156 uses outputs of the operations 152, 154 to compute the distance scale factor 140. In general, the operation of the algorithm 156 can vary according to the H.264 standard depending on the prediction type being performed by the decoder,

In general, section 8.2.1 of the H.264 standard specifies that for two pictures, picA and picB in a sequence, PicOrderCnt(picA)−PicOrderCnt(picB ) is in the range of −2¹⁵ to 2¹⁵−1, inclusive. It has been found that: POCn−POCm=(POCn−POCbase)−(POCm−POCbase). It has been found that the POC values, including those stored in POC Tables, can be correctly replaced by the difference POC values with respect to a common base POC value. Arithmetic operation 152, 154 determine the difference between the POC values 111, 121 and the current picture POC 130 to create POC difference values. In general, the POC difference values can be stored using 16 bits of memory word-length, instead of the 32 bit word length described above with regards to the POC values in the prior art.

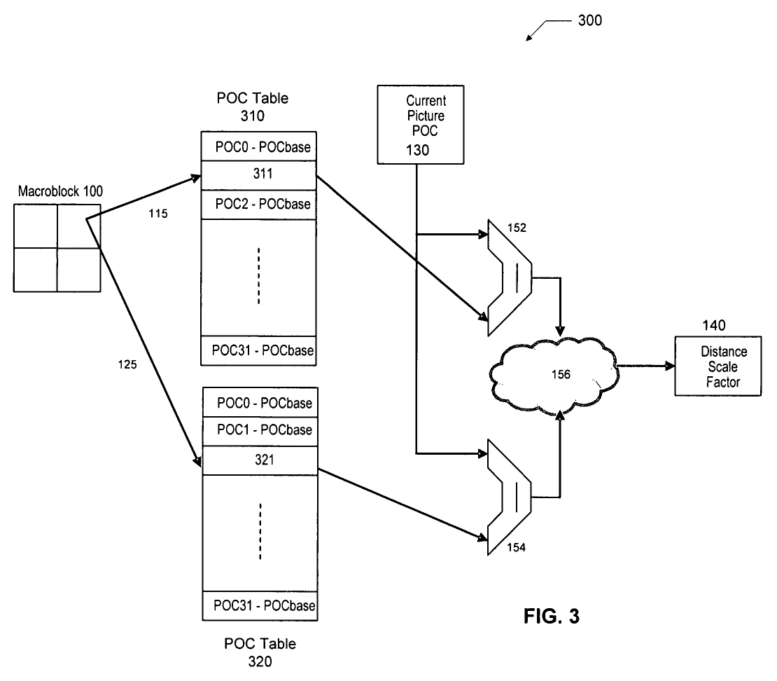

Referring to FIG. 3, with further reference to FIG. 1 and FIG. 2, a system 300 for determining a distance scale factor 140 includes POC tables 310, 320 and POC difference values 311, 321. In general, the POC difference values 311, 321 are the result of subtracting a POC base value from a POC value 111, 121. In an embodiment, the POC tables 310, 320 can be 16-bits wide (i.e., using 16-bit words to store each POC difference entry 311, 321), rather than the 32 bit width of the prior art.

In general, a video decoder can include firmware or execute software configured to receive POC values 111, 121, calculate the POC difference values 311, 321, and store the difference values in the POC tables 310, 320. For example, the firmware and software can include, or select, a common POC base for a given picture sequence or slice, and use the POC base to calculate POC difference values 311, 321 for a particular slice within the picture sequence or slice. In an embodiment, the POC values can be converted to POC difference values in hardware rather than in firmware or software.

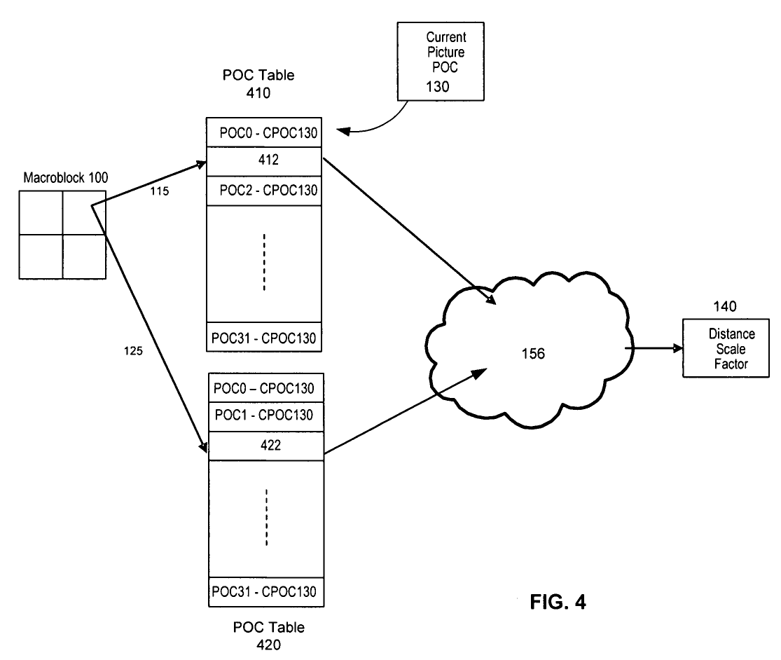

Referring to FIG. 4, with further reference to FIG. 1 and FIG. 2, a system 400 for determining a distance scale factor 140 includes POC tables 410, 420. In general, an offset value is utilized to store a collection of POC difference values 412, 422 associated with the current video slice, rather than storing the POC values received in the slice header. Firmware working with the video decoder prepares POC difference values 412, 422 and stores them in the POC Tables 410, 420. In an embodiment, the offset value used by the decoder to create the POC difference values for populating POC tables 410, 420 is the current picture POC 130. The resulting POC difference values 411, 421 in the tables 410, 420 are 16-bit words (i.e., 16-bit length). Outputs of the tables 410, 420 can be processed directly by the algorithm 156 to determine the distance scale factor 140.

In an embodiment, the POC tables 410, 420 can be separate dedicated memory built into the video decoder for storage of POC difference values. The POC tables 410, 420 can also be part of a larger memory, such as main memory or a video memory shared by devices on a video card, that is separate from the video decoder. Embodiments of the video decoder can be, for example, a single hardware module (e.g., ASIC or FPGA), can comprise various hardware modules (e.g., a daughter card having ASICs and FPGAs), can be a portion of a larger hardware module (e.g. a video decoder core as part of a larger video processor ASIC), software run by a processor (e.g., POC tables are implemented in system memory, and a CPU manipulates POC values, etc.).

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A computer-readable medium having computer-executable instructions for: performing a method for decoding video data, comprising:
receiving a first picture order count value associated with a first video picture and a second picture order count value associated with a second video picture, wherein the picture order count values have a first bit length;
computing a delta value representing a difference between the first picture order count value and the second picture order count value, wherein the delta value has a second bit length that is less than the first bit length; and
storing the delta value in a memory for use by a video processing algorithm.

2. The method of claim 1 wherein the second bit length is approximately half of the first bit length.

3. The method of claim 1 wherein the first bit length is 32 bits and the second bit length is 16 bits.

4. The method of claim 1 wherein the video processing algorithm outputs a distance scale factor.

5. A method for decoding video data, comprising:
receiving a plurality of picture order count values associated with a plurality of video pictures temporally adjacent to a current video picture, wherein each of the picture count values are a first bit length;
calculating a plurality of delta values representing a differences between the plurality of picture order count values and another value, wherein each of the delta values are a second bit length that is less than the first bit length; and
storing the plurality of delta values in a memory device for further processing of the current video picture.

6. The method of claim 5 wherein the further processing of the current video picture includes outputting a distance scale factor.

7. The method of claim 5 wherein the second bit length is approximately half of the first bit length.

8. The method of claim 5 wherein the second bit length is 32 bits and the first bit length is 16 bits.

9. An apparatus for processing a video sequence, comprising:
a memory device operative to store a plurality of first picture order count values, a plurality of second picture order count values, and a current picture order count value;
a processor programmed to:
compute a first arithmetic operation between each of the plurality of first picture order count values and the current picture order count value;
compute a second arithmetic operation between each of the plurality of second picture order count values and the current picture order count value;
determine a distance scale factor based on the first and second arithmetic operations; and
output the distance scale factor.

10. The apparatus of claim 9 wherein the first and second picture order count values are a first bit length, and the results of the first and second arithmetic operations are of a second bit length.

11. The apparatus of claim 10 wherein the second bit length is approximately half of the first bit length.

12. A system for outputting a distance scale factor to a video picture decoder, comprising:
a memory device operative to store a plurality of picture order difference values;
a processor programmed to:
receive a plurality of reference index values;
compute each of the plurality of picture order difference values by subtracting an offset value from each of the plurality of reference index values;
storing each of the picture order difference values in the memory device;
processing the plurality of picture order difference values with an algorithm to produce the distance scale factor; and
outputting the distance scale factor.

13. The system of claim 12 wherein each of the plurality of reference index values are a first bit length, and each of the plurality of picture order difference values are a second bit length.

14. The system of claim 13 wherein the second bit length is less than the first bit length.

15. The system of claim 14 wherein the second bit length is 16 bits and the first bit length is 32 bits.
